(19) United States
(12) Patent Application Publication
(10) Pub. No.: US 2012/0016999 A1
(43) Pub. Date: Jan. 19, 2012

(54) Context for Sharing Data Objects

(75) Inventors: Oliver Kieselbach, Walldorf (DE); Ulf Fildebrandt, Walldorf (DE)

(73) Assignee: SAP AG, Walldorf (DE)

(21) Appl. No.: 12/836,123

(22) Filed: Jul. 14, 2010

(51) Int. Cl. G06F 15/16

(52) U.S. Cl. 709/229

(57) ABSTRACT

The present disclosure involves systems, software, and computer implemented methods for providing a context service for sharing data objects among different components. One process includes operations for receiving a data object for inclusion in a hosted context storage and determining user information associated with a client with access to the data object. After the data object and the user information are stored in the hosted context storage, a request for the data object is received from the client. The data object is provided to the client based on an authentication status of the client.

### TECHNICAL FIELD

The present disclosure relates to software, computer systems, and computer implemented methods for providing a context service for sharing data objects among different components.

### BACKGROUND

Computer applications frequently process data provided by systems from different domains, with the different systems providing data in different formats or protocols. In some instances, the complexity of the data exchanged between different systems, the large amounts of data, incompatibilities among different formats, and other factors may result in inefficiencies when applications receive, process, and transmit data to and from different sources across a network. Some solutions, including a variety of programming paradigms such as Service-Oriented Architecture (SOA) systems, are designed for handling large amounts of data shared among multiple systems. Even in SOA systems, the data may be copied from one system to another system by passing the data as messages. The data messages may, in some instances, contain extraneous, irrelevant, or generic data. Further, some of the data messages may be transferred across multiple systems a number of times via point to point communications. As the amount of data messages transported across networks increases over time, the performance of networks and applications may be negatively affected. Systems that share or exchange data, including systems that provide or receive on-demand services through a cloud network, may require efficient solutions for providing large amounts of data to different applications.

Further, applications or systems may be associated with a common business process or objective. Applications from different domains may need to collaborate with respect to a particular business objective or need to access common data objects. The data objects may need to be transmitted between applications each time a particular data object is updated and processed during collaboration, resulting in inefficient allocation of resources. Allowing applications to access a common storage for processing of shared data objects may compromise the security measures implemented in the common storage. The security concerns inherent in systems providing shared data objects may hinder the accessibility of the shared data objects.

### SUMMARY

The present disclosure describes techniques for providing a context service for sharing data objects among different components. A computer program product is encoded on a tangible storage medium, where the product comprises computer readable instructions for causing one or more processors to perform operations. These operations can include receiving a data object for inclusion in a hosted context storage and determining user information associated with a client with access to the data object. After the data object and the user information are stored in the hosted context storage, a request for the data object is received from the client. The data object is provided to the client based on an authentication status of the client.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment implementing various features of a context service for sharing data objects among different components;

FIGS. 2A-C depict example logical representations of the contents of a context as an on-demand service using an appropriate system, such as the system described in FIG. 1;

FIG. 3 depicts an example configuration of a context service coupled with different components for sharing data objects using an appropriate system, such as the system described in FIG. 1;

FIG. 4 depicts an example configuration of a context service coupled with different components for sharing data objects using an appropriate system, such as the system described in FIG. 1;

FIG. 5 is a flowchart of an example process for providing accessibility to data objects in a context as an on-demand service using an appropriate system, such as the system described in FIG. 1; and

FIG. 6 illustrates an example flow sequence of an originating client using a context service to create a data object and define a set of users for collaboration on the data object using an appropriate system, such as the system described in FIG. 1.

### DETAILED DESCRIPTION

This disclosure generally describes computer systems, software, and computer implemented methods for providing a context service for sharing data objects among different components. Large amounts of data may be exchanged across a network between different systems. Different applications or components may access common data objects, but in some instances, the data objects used by multiple applications may need to be transmitted between the applications. Although the data objects may be transmitted across a network as data messages, the exchange of large amounts of messages between servers may impact the performance of the servers or network. A general context solution may hold data objects for applications that are distributed among many systems, allowing various applications from different domains to access a common data object in an efficient manner and collaborate in the processing of the common data object. In some instances, the general context solution may be provided to systems through a cloud network or on the premises of a particular client.

In some implementations, the context service includes a storage of data provided for applications that may need to retrieve or access the data for certain tasks before the data is passed to other applications, including applications of different types or applications in different domains. The context service may be implemented as an on-premise solution as well as made accessible to on-demand applications through a network such as a cloud network. Access to the context may be restricted for certain applications for security reasons. In certain implementations, only invited users or tenants have access to the data. Accordingly, the context may consist of a combination of stored data as well as user information identifying or verifying the users that have access to the data object. The context solution can be beneficial for providing accessibility to shared data in on-demand solutions or other implementations involving integration of cloud-based services with on-premise systems.

One potential benefit of the context service for sharing data objects of the present disclosure is that data objects may be shared with a plurality of components or applications in an efficient manner. The data objects may not need to be transmitted directly between applications, which requires communication resources that may be insufficient due to the size or complexity of the data objects. Further, the data objects may need to be accessed by applications from different domains, and the applications may operate in collaboration to update and process the data objects. Thus, an easily accessible service or storage for retrieving shared data objects may facilitate collaboration among applications from different domains for processing shared data objects. Providing the context service in a cloud network implementation also increases flexibility and efficiency when allowing applications from different locations and domains to access the data objects within a particular context storage.

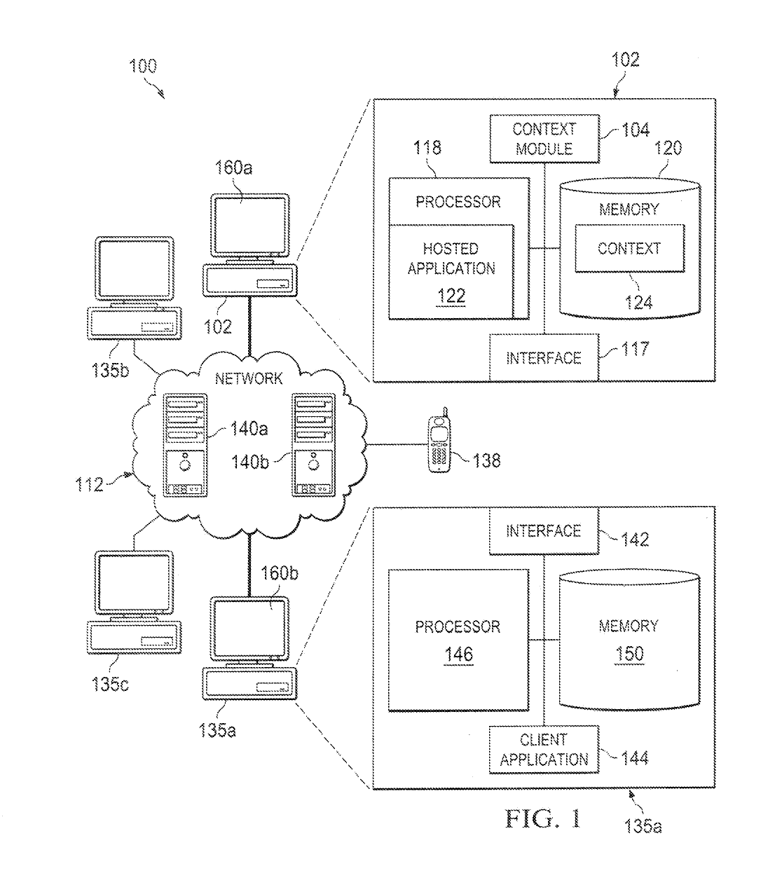

Turning to the illustrated example, FIG. 1 illustrates an example environment 100 for providing a context service for sharing data objects among different components. The illustrated environment 100 includes or is communicably coupled with server 102 and one or more clients 135, at least some of which communicate across network 112. In general, environment 100 depicts an example configuration of a system capable of providing a storage of data accessible to components and applications from different domains. The environment 100 also supports one or more servers 140 operable to access the client 135 or server 102 in which the one or more servers 140 and server 102 can be logically grouped and accessible within a cloud computing network. Accordingly, the context service for sharing data objects among different components may be provided to a client 135 or server 140 as an on-demand solution through the cloud computing network or as a traditional server-client system.

In general, server 102 is any server that stores one or more hosted applications 122, where at least a portion of the hosted applications 122 are executed via requests and responses sent to users or clients within and communicably coupled to the illustrated environment 100 of FIG. 1. For example, server 102 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the server 102 may store a plurality of various hosted applications 122, while in other instances, the server 102 may be a dedicated server meant to store and execute only a single hosted application 122. In some instances, the server 102 may comprise a web server or be communicably coupled with a web server, where the hosted applications 122 represent one or more web-based applications accessed and executed via network 112 by the clients 135 of the system to perform the programmed tasks or operations of the hosted application 122.

At a high level, the server 102 comprises an electronic computing device operable to receive, transmit, process, store, or manage data and information associated with the environment 100. The server 102 illustrated in FIG. 1 can be responsible for receiving application requests from one or more client applications 144 or business applications associated with the clients 135 of environment 100 and responding to the received requests by processing said requests in the associated hosted application 122, and sending the appropriate response from the hosted application 122 back to the requesting client application 144. The server 102 may also receive requests and respond to requests from other components on network 112 such as servers 140a-b in a cloud network implementation or other components such as other clients 135a-c. Alternatively, the hosted application 122 at server 102 can be capable of processing and responding to local requests from a user accessing server 102 locally. Accordingly, in addition to requests from the external clients 135 illustrated in FIG. 1, requests associated with the hosted applications 122 may also be sent from internal users, external or third-party customers, other automated applications, as well as any other appropriate entities, individuals, systems, or computers. Further, the terms “client application” and “business application” may be used interchangeably as appropriate without departing from the scope of this disclosure.

As used in the present disclosure, the term “computer” is intended to encompass any suitable processing device. For example, although FIG. 1 illustrates a single server 102, environment 100 can be implemented using one or more servers 102, as well as computers other than servers, including a server pool. Indeed, server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any operating system, including Linux, UNIX, Windows, Mac OS, or any other suitable operating system. According to one embodiment, server 102 may also include or be communicably coupled with a mail server.

In the present implementation, and as shown in FIG. 1, the server 102 includes a processor 118, an interface 117, a memory 120, one or more hosted applications 122, and a context module 104. The interface 117 is used by the server 102 for communicating with other systems in a client-server or other distributed environment (including within environment 100) connected to the network 112 (e.g., client 135, as well as other systems communicably coupled to the network 112). Generally, the interface 117 comprises logic encoded in software and/or hardware in a suitable combination and operable to communicate with the network 112. More specifically, the interface 117 may comprise software supporting one or more communication protocols associated with communications such that the network 112 or interface's hardware is operable to communicate physical signals within and outside of the illustrated environment 100.

The server 102 may also include a user interface, such as a graphical user interface (GUI) 160a. The GUI 160a comprises a graphical user interface operable to, for example, allow the user of the server 102 to interface with at least a portion of the platform for any suitable purpose, such as creating, preparing, requesting, or analyzing data, as well as viewing and accessing source documents associated with business transactions. Generally, the GUI 160a provides the particular user with an efficient and user-friendly presentation of business data provided by or communicated within the system. The GUI 160a may comprise a plurality of customizable frames or views having interactive fields, pull-down lists, and buttons operated by the user. For example, GUI 160a may provide interactive elements that allow a user to select from a list of suggested entries for input into a data field displayed in GUI 160a. More generally, GUI 160a may also provide general interactive elements that allow a user to access and utilize various services and functions of application 122. The GUI 160a is often configurable, supports a combination of tables and graphs (bar, line, pie, status dials, etc.), and is able to build real-time portals, where tabs are delineated by key characteristics (e.g. site or micro-site). Therefore, the GUI 160a contemplates any suitable graphical user interface, such as a combination of a generic web browser, intelligent engine, and command line interface (CLI) that processes information in the platform and efficiently presents the results to the user visually.

Generally, example server 102 may be communicably coupled with a network 112 that facilitates wireless or wireline communications between the components of the environment 100 (i.e., between the server 102 and client 135, between servers 140 and 102, as well as between mobile device 138 and server 102 or client 135), as well as with any other local or remote computer, such as additional clients, servers, or other devices communicably coupled to network 112 but not illustrated in FIG. 1. In the illustrated environment, the network 112 is depicted as a single network in FIG. 1, but may be a continuous or discontinuous network without departing from the scope of this disclosure, so long as at least a portion of the network 112 may facilitate communications between senders and recipients. The network 112 may be all or a portion of an enterprise or secured network, while in another instance at least a portion of the network 112 may represent a connection to the Internet. In some instances, a portion of the network 112 may be a virtual private network (VPN), such as, for example, the connection between the client 135 and the server 102. Further, all or a portion of the network 112 can comprise either a wireline or wireless link. Example wireless links may include 802.11a/b/g/n, 802.20, WiMax, and/or any other appropriate wireless link. In other words, the network 112 encompasses any internal or external network, networks, sub-network, or combination thereof operable to facilitate communications between various computing components inside and outside the illustrated environment 100. The network 112 may communicate, for example, Internet Protocol (IP) packets, Frame Relay frames, Asynchronous Transfer Mode (ATM) cells, voice, video, data, and other suitable information between network addresses. The network 112 may also include one or more local area networks (LANs), radio access networks (RANs), metropolitan area networks (MANs), wide area networks (WANs), all or a portion of the Internet, and/or any other communication system or systems at one or more locations.

Clients 135a-c may have access to resources such as servers 140a-b and 102 within network 112. In certain implementations, the servers 140 within the network 112, including server 102 in some instances, may comprise a cloud computing platform for providing cloud-based services. The terms “cloud,” “cloud computing,” and “cloud-based”may be used interchangeably as appropriate without departing from the scope of this disclosure. Cloud-based services can be hosted services that are provided by servers and delivered across a network to a client platform to enhance, supplement, or replace applications executed locally on a client computer. Clients 135 can use cloud-based services to quickly receive software upgrades, applications, and other resources that would otherwise require a lengthy period of time before the resources can be delivered to the client 135. Servers 140 within the network 112 may also utilize the on-demand functionality of cloud-based services such as sharing data in a context provided at a server such as server 102. Additionally, mobile device 138 may also have access to cloud-based services, such as on-demand services provided by servers accessible through network 112.

As described in the present disclosure, on-demand services can include multiple types of services such as products, actionable analytics, enterprise portals, managed web content, composite applications, or capabilities for creating, integrating, and presenting business applications. For example, a cloud-based implementation can allow clients 135 to transparently upgrade from an older user interface platform to newer releases of the platform without loss of functionality. In certain implementations, a context service can provide a storage of shared data objects as an on-demand service to various components such as servers 140a-b and clients 135a-c. Using the context service, the servers 140a-b and clients 135a-c may each access shared data objects through the cloud network for processing without requiring direct point-to-point communications between individual servers or clients. The data objects may be efficiently shared among distributed systems from different domains. For example, different applications may collaboratively update a shared data object provided by the context without having to directly transfer the shared data object among the participating applications. The shared data object may further be associated with a business process executed at clients 135a-c or servers 140a-b, and the shared data object may be accessed at each step of the business process by different applications. The context service may also associate the shared data object with particular applications that are granted access to the data object.

As illustrated in FIG. 1, server 102 includes a processor 118. Although illustrated as a single processor 118 in FIG. 1, two or more processors may be used according to particular needs, desires, or particular embodiments of environment 100. Each processor 118 may be a central processing unit (CPU), a blade, an application specific integrated circuit (ASIC), a field-programmable gate array (FPGA), or another suitable component. Generally, the processor 118 executes instructions and manipulates data to perform the operations of server 102 and, specifically, the one or more plurality of hosted applications 122. Specifically, the server's processor 118 executes the functionality required to receive and respond to requests from the clients 135 and their respective client applications 144, as well as the functionality required to perform the other operations of the hosted application 122.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate. In the illustrated environment 100, processor 118 executes one or more hosted applications 122 on the server 102.

At a high level, each of the one or more hosted applications 122 is any application, program, module, process, or other software that may execute, change, delete, generate, or otherwise manage information according to the present disclosure, particularly in response to and in connection with one or more requests received from the illustrated clients 135 and their associated client applications 144 or from other servers or components through a network 112. In certain cases, only one hosted application 122 may be located at a particular server 102. In others, a plurality of related and/or unrelated hosted applications 122 may be stored at a single server 102, or located across a plurality of other servers 102, as well. In certain cases, environment 100 may implement a composite hosted application 122. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the hosted applications 122 may represent web-based applications accessed and executed by remote clients 135 or client applications 144 via the network 112 (e.g., through the Internet). Further, while illustrated as internal to server 102, one or more processes associated with a particular hosted application 122 may be stored, referenced, or executed remotely. For example, a portion of a particular hosted application 122 may be a web service associated with the application that is remotely called, while another portion of the hosted application 122 may be an interface object or agent bundled for processing at a remote client 135. Moreover, any or all of the hosted applications 122 may be a child or sub-module of another software module or enterprise application (not illustrated) without departing from the scope of this disclosure. Still further, portions of the hosted application 122 may be executed by a user working directly at server 102, as well as remotely at client 135.

As illustrated, processor 118 can also execute a context module 104 that provides services for applications such as hosted application 122, client application 144, or servers 140 within network 112. In some implementations, the context module 104 can be executed by a different processor or server external to server 102, such as by a server communicably coupled to server 102 through network 112. For example, the context module 104 may be provided as an on-demand service through a cloud computing network, as a web service accessible via network 112, or as a service provided on a dedicated server. The context module 104 can provide interfaces, modules, services, or metadata definitions that enable hosted application 122 to provide accessibility to data objects stored in a context storage 124 within memory 120 at server 102. The context module 104 can also include functionality to associate data objects within context 124 with particular clients 135 or servers 140 that may need to access the data objects in context 124. In other words, the context module 104 may limit the accessibility of certain data objects within context 124 to approved users. The approved users that are allowed access to data objects in context 124 may be users that are collaborating with respect to certain data objects in connection with a shared business objective, for example. As used in the present disclosure, the context module 104 can be provided as a context service, which may include providing access to data objects stored within a memory 120. The data objects and any user information associated with the data objects that may be used to identify or verify users granted to the data objects may be stored in a data structure such as context 124 within memory 120. Accordingly, as used in the present disclosure, the terms “context,” “context storage,” and “context service” may be used interchangeably without departing from the scope of the present disclosure.

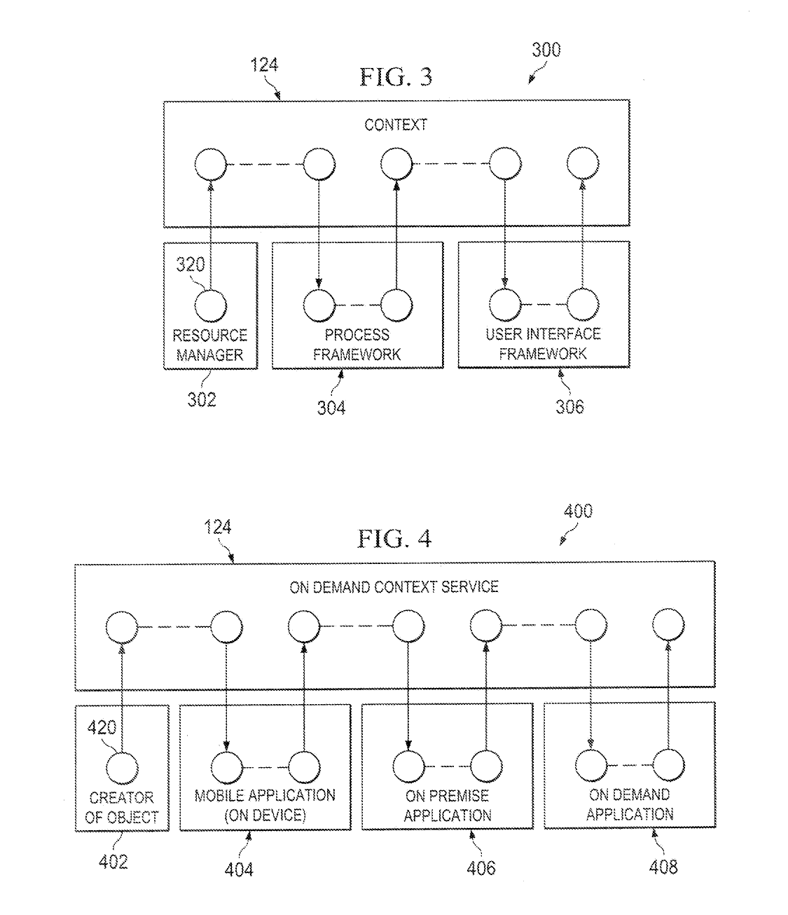

The context module 104 may be separate from hosted application 122, while in other instances, the context module 104 may be embedded within or part of a particular one or more hosted applications. In some instances, hosted application 122 may be communicably coupled to the context module 104, allowing hosted application 122 to access and take advantage of the functionality provided by the context module 104. One example of an implementation of the context module 104 is described in detail below in connection with FIG. 3. Further, context module 104 may be implemented in connection with a servlet and a servlet container in server 102 or a different server communicably coupled with server 102. The servlet may be used to provide dynamic content to server 102 for receiving requests for data objects within context 124 and generating appropriate responses to the requests.

In general, the server 102 also includes memory 120 for storing data and program instructions. Memory 120 may include any memory or database module and may take the form of volatile or non-volatile memory including, without limitation, magnetic media, optical media, random access memory (RAM), read-only memory (ROM), removable media, or any other suitable local or remote memory component. Memory 120 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 102 and its one or more hosted applications 122.

Memory 120 may also store data objects such as data objects in a context 124 accessible to different components through a cloud network and provided by a context on-demand service. The context on-demand service provides accessibility to a plurality of entities such as applications, frameworks, devices, or other components that may need to process a shared data object. The components may need to process the shared data objects in collaboration with each other based on an associated business process or a shared objective. Accordingly, the context 124 may include additional functionality in addition to a storage for shared data objects. For example, to facilitate collaboration by the various components on a shared data object, the context 124 in memory 120 may also store user or tenant information associated with each component. Based on the stored user/tenant information, only portions of a particular application or only invited users may access the context 124, for example. Thus, the user/tenant information may be used to ensure secure communications with the context 124 by various components. Still further, memory 120 may include any other appropriate data, such as VPN applications, firmware logs and policies, HTML files, data classes or object interfaces, unillustrated software applications or sub-systems, firewall policies, a security or access log, print or other reporting files, as well as others.

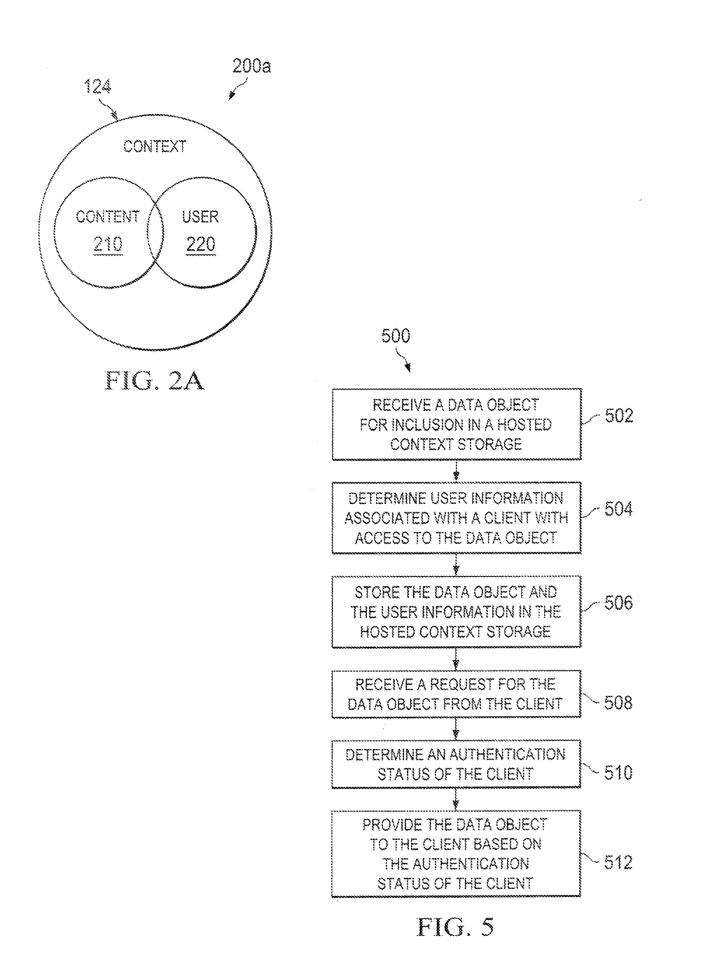

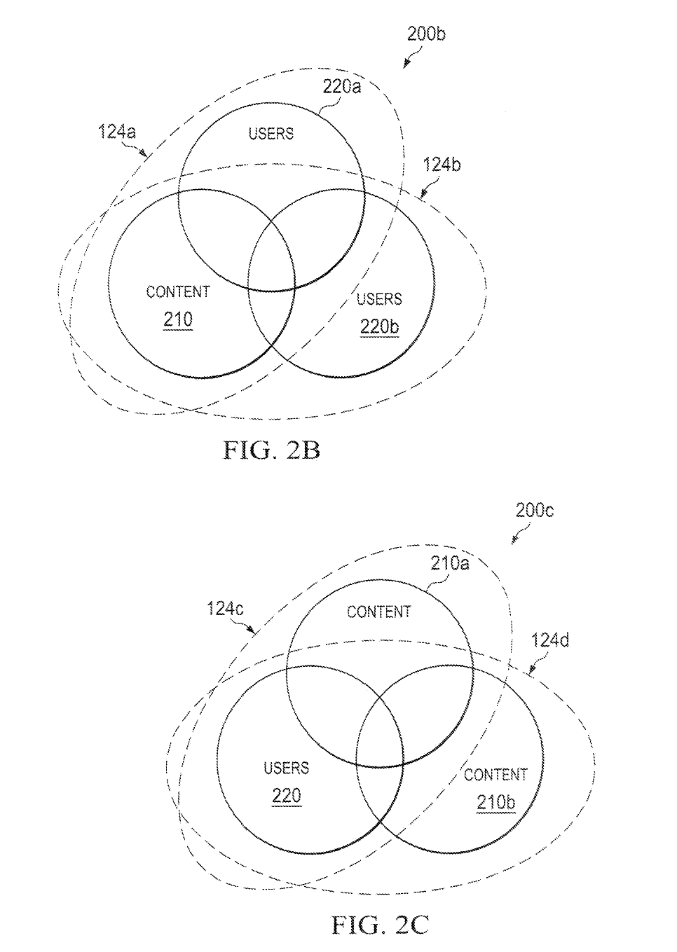

As described above, context 124 stores appropriate data suitable for facilitating collaboration on shared content for users from different domains. Thus, context 124 may include both the data objects as well as user information associated with the users who are provided access to the content of context 124. FIG. 2A depicts an example logical representation 200a of the arrangement of the contents in context 124. At least some of the content 210 within context 124 may be logically grouped together. The content 210 may consist of data objects that are to be shared among a particular group of users 220 according to various criteria. For example, a creator of the data objects in content 210 may define business rules or parameters restricting access to the data objects. According to the parameters, the group of users 220 may be given access to some or all of content 210. Thus, the content 210 and the information associated with the group of users 220 that have access to content 210 can be included within context 124 as illustrated in FIG. 2A.

Further, as illustrated in another logical representation 200b of a context in FIG. 2B, a context may involve multiple groupings of users associated with particular content 210, with each grouping of users and portions of content 210 defined as a separate context. For example, a first group of users 220a may have access to a first subset of content 210 while a second group of users 220b may have access to a second subset of content 210. In some instances, users within the first group 220a may have access to some of the same content as users within the second group 220b. The pairing of the first group of users 220a and the content 210 may be defined as a first context 124a while the pairing of the second group of users 220b and the content 210 may be defined as a second context 124b. As illustrated in FIG. 2B, some users may be included in both the first context 124a and the second context 124b. In any event, contexts 124a-b each include at least a group of users, content to be shared with the group of users, and parameters required for sharing the content, such as parameters indicating particular users that have access to particular data objects in the shared content.

Alternatively, as depicted in FIG. 2C, a set of users may be grouped with different content according to different contexts. For example, a first subset of users 220 may be given access to at least some of a first unit of content 210a while a second subset of users 220 may be given access to at least some of a second unit of content 210b. In some instances, portions of content 210a may overlap with portions of content 210b. In any event, different contexts can be defined to include various groupings of users and different content. In the illustrated example, users that have access to content 210a may be included with content 210 in a first context 124c while users given access to content 210b may be included with content 210b in a second context 124d. In other words, context 124 may include the necessary content, user information, parameters, and business rules necessary for a plurality of users to share and collaborate on content stored in context 124.

The illustrated environment of FIG. 1 also includes one or more clients 135a-c. Each client 135 may be any computing device operable to connect to or communicate with at least the server 102 and/or via the network 112 using a wireline or wireless connection. Further, as illustrated in FIG. 1, client 135 includes a processor 146, an interface 142, a graphical user interface (GUI) 160b, a client application 144, and a memory 150. In general, client 135 comprises an electronic computer device operable to receive, transmit, process, and store any appropriate data associated with the environment 100 of FIG. 1. It will be understood that there may be any number of clients 135 associated with, or external to, environment 100. For example, while illustrated environment 100 includes client 135a, alternative implementations of environment 100 may include multiple clients communicably coupled to the server 102, or any other number of clients suitable to the purposes of the environment 100. Additionally, there may also be one or more additional clients 135 external to the illustrated portion of environment 100 that are capable of interacting with the environment 100 via the network 112. Further, the term “client” and “user” may be used interchangeably as appropriate without departing from the scope of this disclosure. The term “client” may also refer to any computer, application, or device, such as mobile device 138, that is communicably coupled to one or more servers through a network 112. Moreover, while each client 135 is described in terms of being used by a single user, this disclosure contemplates that many users may use one computer, or that one user may use multiple computers.

The GUI 160b associated with client 135a comprises a graphical user interface operable to, for example, allow the user of client 135a to interface with at least a portion of the platform for any suitable purpose, such as creating, preparing, requesting, or analyzing data, as well as viewing and accessing source documents associated with business transactions. Generally, the GUI 160b provides the particular user with an efficient and user-friendly presentation of business data provided by or communicated within the system. The GUI 160b may comprise a plurality of customizable frames or views having interactive fields, pull-down lists, and buttons operated by the user. More generally, GUI 160b may also provide general interactive elements that allow a user to access and utilize various services and functions of application 144. The GUI 160b is often configurable, supports a combination of tables and graphs (bar, line, pie, status dials, etc.), and is able to build real-time portals, where tabs are delineated by key characteristics (e.g. site or micro-site). Therefore, the GUI 160b contemplates any suitable graphical user interface, such as a combination of a generic web browser, intelligent engine, and command line interface (CLI) that processes information in the platform and efficiently presents the results to the user visually.

As used in this disclosure, client 135 is intended to encompass a personal computer, touch screen terminal, workstation, network computer, kiosk, wireless data port, smart phone, personal data assistant (PDA), one or more processors within these or other devices, or any other suitable processing device. For example, each client 135 may comprise a computer that includes an input device, such as a keypad, touch screen, mouse, or other device that can accept user information, and an output device that conveys information associated with the operation of the server 102 (and hosted application 122) or the client 135 itself, including digital data, visual information, the client application 144, or the GUI 160b. Both the input and output device may include fixed or removable storage media such as a magnetic storage media, CD-ROM, or other suitable media to both receive input from and provide output to users of client 135 through the display, namely, the GUI 160b.

While FIG. 1 is described as containing or being associated with a plurality of elements, not all elements illustrated within environment 100 of FIG. 1 may be utilized in each alternative implementation of the present disclosure. For example, although FIG. 1 depicts a server-client environment implementing a hosted application at server 102 that can be accessed by client computer 135, in some implementations, server 102 executes a local application that features an application UI accessible to a user directly utilizing GUI 160a. Further, although FIG. 1 depicts a server 102 external to network 112 while other servers 140 are within the network 112, server 102 may be included within the network 112 as part of an on-demand context solution, for example. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

FIG. 3 depicts an example configuration 300 of a context service coupled with different components for sharing data objects. As illustrated in FIG. 3, various components including a resource manager 302, a process framework 304, and a user interface (UI) framework 306 may be communicably coupled with a context 124. The context 124 may be available to the components as an on-premise repository or storage or as an on-demand service provided in association with a cloud network such as network 112. As described above in connection with FIG. 1, a context 124 may be a data structure or storage of data objects accessible to a set of components for processing of the data objects in the context 124. In some instances, the components may collaboratively update the data objects within the context 124 based on an associated business process step. For example, the resource manager 302 may generate a new data object 320 and store the new data object 320 within the context 124 so that other applications or frameworks may access the newly created data object 320. The data object 320 may be software components such as a set of services for facilitating application development such as Web Beans or Spring Dynamic Modules for OSGi Service Platforms, for example.

After the data object 320 has been generated and included in the context 124, a process framework 304 may retrieve the data object 320 from the context 124 for further processing and development. The process framework 304 may then return the data object 320 to the context 124 once the data object 320 has been updated by the process framework 304. A UI framework 306 may also retrieve the data object 320 from the context 124 for particular tasks such as generation of user interface elements. As seen in FIG. 3, the data object 320 is accessible to several different components, such as resource manager 302, process framework 304, and user interface (UI) framework 306 while the data object 320 resides in the context 124. Thus, the various components that need the data object 320 for further processing can retrieve the data object 320 from one location without directly communicating with the other components. Data objects may be retrieved from the context 124 for manipulation purposes and returned to the context 124 at the appropriate time. As a result, applications and components of different domains can access, utilize, and update shared data objects through the context 124.

In some implementations, the context 124 is an additional capability of a system. Different frameworks may use the context 124 for sharing data objects, but the frameworks are not necessarily directly dependent on the context 124. In other words, the frameworks associated with the context 124 may not always use the context 124 to share data objects, and a particular application associated with a framework may decide whether to reference the context 124. Further, the context 124 may support a number of different data objects. For example, data objects ranging from complete business objects to simple Java objects may be included in the context 124.

FIG. 4 depicts another example configuration 400 of a context service coupled with different components for sharing data objects. As illustrated in FIG. 4, the context service may be provided as an on-demand service through a cloud network. A particular service or application 402 may create a data object 420 for inclusion in the context 124. The application 420 may be any type of application suitable for creating data objects and pushing created data objects onto a context 124 available through a cloud network. The applications include simple Java applications or other types of applications. In some instances, the data object 420 to be shared in the context 124 may be any type of data object suitable for storage in the context 124. For example, application 402 may create a JavaScript Object Notation (JSON) resource for insertion into the context. The language-independent features of JSON resources may facilitate collaboration among systems from different domains.

The on-demand context service illustrated in FIG. 4 may be any storage of data objects accessible through a cloud network and stored on a server. In certain implementations, the context 124 may be defined by a servlet implemented on a web server, for example. The web server may be used to provide a HyperText Transfer Protocol (HTTP) end point and a servlet container and environment for the servlet. In some instances, the servlet can receive requests for data objects in the context and generate responses to the requests. The on-demand context service, however, may be de-coupled from a specific user interface implementation in some instances. In addition, the context service may be a service in a particular cloud computing infrastructure such as cloud platforms enabling users to create, customize, launch, and manage their own server instances. Further, the context 124 may be provided on a single server over a network or may be distributed across multiple servers and accessible through the cloud network. Moreover, the implementations listed above are merely examples of appropriate mechanisms for providing a context 124 for different components. Other types of hosting entities may be used to provide a context 124 and are within the scope of the present disclosure.

After the data object 420 has been stored in the context 124, other applications or frameworks may have access to the data object 420 through the on-demand context service, as depicted in FIG. 4. In some implementations, the creator of the data object 402 may invite other applications or frameworks to access the data object 420 for collaboration. For example, a particular user may create a data object in an application for storage in the context 124. The user may then submit invitations to other users for collaboration on the data object. In certain instances, the context 124 may also be provided in connection with a tenant implementation. A tenant may be an entity, such as a business organization, associated with a context 124 or with particular data objects within the context 124. The tenant may further be associated with business rules or constraints defining which users within the entity may have access to particular data objects. In some instances, each user within a particular tenant may have access to a particular data object. Accordingly, groups of users may be given access to particular data objects in the context depending on the implementation and tenants involved. Moreover, data objects may be shared among certain users across multiple tenants so that users belonging to tenants in different domains may still collaborate on the same data objects.

Further, based on a business objective or business process associated with particular data objects within the context 124, the context 124 may provide only limited access to certain applications that need to access the context 124. In some implementations, the context service may utilize an authentication procedure to restrict access to the context 124. For example, an identity management system may be employed in connection with the context 124 to manage the security credentials of various tenants, users, or applications that are given access to the context 124. A particular context identification may be required to gain access to the context 124 or a subset of the data objects in the context 124. A public/private key encryption system may also be implemented to determine the applications or users that are allowed to retrieve data objects from the context 124. The authentication procedure may be used in connection with or as an alternative to a tenant implementation in which users associated with a particular tenant are given predefined access privileges to the context 124 without requiring additional authentication.

The applications that are given access to the context 124 may be any type of device, framework, or application capable of accessing the context 124 in the cloud network for data objects stored in the context 124. For example, a mobile device application 404 may have an on-device service that needs access to the data object 420 in the context 124 for processing. The mobile device application 404 may retrieve the data object 420 from the context 124 for manipulation before pushing the data object 420 onto the context 124 again for other applications. Further, as seen in FIG. 4, the applications 406 and 408 that may have access to the data object 420 through the context 124 may be on-premise applications 406 or on-demand applications 408. Context 124 can be accessed by web application user interface frameworks via an HTTP client or by a mobile applications, for example. In other words, the applications and frameworks that have access to the context 124 are not limited to a single system. Instead, any application, framework, or device connected to the context through a network, such as a cloud computing network, may utilize the context 124 to access data objects for collaboration and processing.

Various components may submit requests to the context 124 for access to data objects stored in the context 124. Requests to the context for accessing of data objects can be implemented in conformity with Representational State Transfer (REST) type formats, which may maximize the use of pre-existing, predefined interfaces and other built-in capabilities provided by a chosen network protocol, such as HTTP, and minimize the addition of new application-specific features on top of the network protocol. Further, requests to the context 124 may also be secured using encryption methods such as MD5 or private/public key encryption, for example. In some implementations, the context 124 may be defined such that only portions of a particular application have access to the context 124 or only invited users or tenants have access to the data. Accordingly, the context 124 may include a combination of data and user information.

FIG. 5 illustrates an example process 500 for providing accessibility to data objects in a context 124 as an on-demand service. First, a data object is received for inclusion in a hosted context storage 124 at 502. The data object may be generated by a particular client for the purpose of collaborating with other clients on a business objective that may involve the data object. The particular client may utilize the context 124 so that other clients may access the data object through the cloud network 112. Next, a context module 104 associated with the context 124 may determine user information associated with a client that may have access to the data object at 504. The user information may be any information needed to identify or authenticate a client that is permitted to access a particular data object in the context 124. The user information may include information about a single client or any number of clients associated with a particular data object that has been granted permission to access the data object.

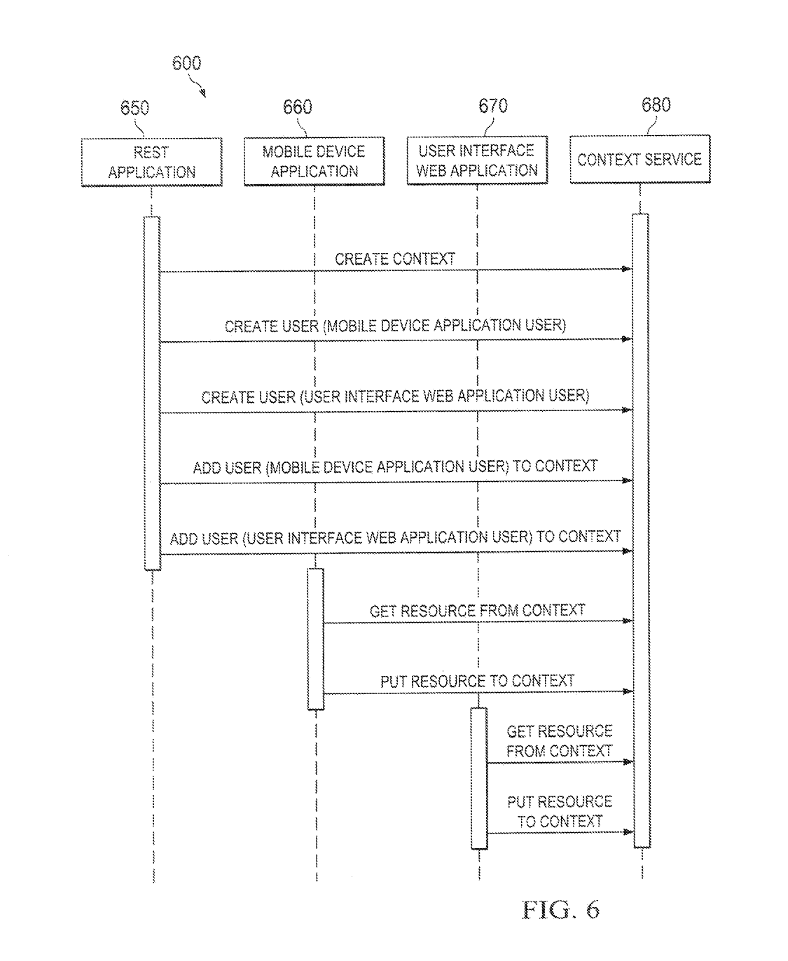

In some implementations, a limited number of clients may be given access to the data object in context 124, depending on the situation. For example, the client that generated the data object may invite other clients or users to access the data object in context 124 in accordance with a shared business objective. Thus, the originating client may provide the necessary user information to the context module 104, indicating the clients that have permission to access the data object. As described below in connection with FIG. 6, the originating client may indicate the users that will have access to the data object. Alternatively, context module 104 may dynamically determine the user information from the parameters and attributes of the data object, and thereby identifying a list of clients that may be permitted to access the data objects in the context 124. The dynamically determined user information may comprise a default list of users that are initially given access to the data objects in context 124 absent other information. Still further, the context module 104 may incorporate a tenant system when determining user information. A tenant may be a business organization comprised of multiple users. Any number of business rules or constraints may be associated with a particular tenant, and based on the associated business rules or constraints, one or more of the users within the tenant may have access to particular data objects in context 124. Depending on the business rules associated with the tenant, certain users may have access to certain data objects while other users may have access to a different set of data objects. In some implementations, the context module 104 may identify multiple tenants associated with particular data objects and determine user information across the various tenants. The context module 104 may also identify users not included in an identified tenant to be allowed access to the data objects in context 124.

Returning to the process 500 illustrated in FIG. 5, after the user information associated with one or more clients has been determined, the data object and user information is stored in the hosted context storage at 506. In other words, context 124 may include the content of the data objects as well as user information identifying and verifying the clients that may have access to the data objects. At 508, a request may be received for a particular data object in context 124, and the context module 104 may determine an authentication status of the client at 510. As described above in connection with the user information determined at 504, the client may be associated with predetermined user information that identifies the clients given permission to access a particular data object, and the context module 104 may authenticate the client based on the user information. Alternatively, the client requesting access to the data object may be authenticated using any other appropriate means, including public and private key encryption methods, for example. After the requesting client has been authenticated by context module 104, the data object is provided to the client at 512.

FIG. 6 illustrates an example flow sequence 600 of an originating client using a context service to create a data object and define a set of users for collaboration on the data object. As illustrated, an originating application 650 such as an application associated with a Representational State Transfer (REST) type format may initiate creation of a context 124 by invoking a context service 680. The context 124 may include a data object to be used by the originating application 650 or other applications as defined by application 650. After the originating application 650 has initiated creation of a context 124, it may create additional users through the context service 680 that may have access to the context 124. As depicted in FIG. 6, for example, the additional users may be additional applications or devices such as a mobile device application 660 or a user interface web application 670. Once created, the created users 660 and 670 are added to the context 124 as user information for identifying the users given access to the context 124. Accordingly, the mobile device application 660 and user interface web application may each invoke context service 680 to get data objects from the context 124, process the data objects, and return the data objects to the context 124, as illustrated in FIG. 6.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer implemented method performed by one or more processors for providing access to a shared data object, the method comprising the following operations:
receive a data object for inclusion in a hosted context storage;
determine user information associated with at least one client with access to the data object;
store the data object and the user information in the hosted context storage;
receive a request for the data object from the at least one client;
determine an authentication status of the at least one client; and
provide the data object to the at least one client based on the authentication status of the at least one client.

2. The method of claim 1, wherein storing the data object and the user information in the hosted context storage further comprises providing access to the hosted context storage through a cloud network.

3. The method of claim 2, wherein providing access to the data object in the hosted context storage includes providing access to a plurality of clients, at least two of the plurality of clients from different domains.

4. The method of claim 1, wherein determining the authentication status of the at least one client includes:
identifying a tenant associated with the at least one client; and
determining whether the at least one client is authorized to access the data object based on a set of business rules associated with the tenant.

5. The method of claim 4, wherein identifying a tenant associated with the at least one client includes determining whether the tenant is one of a plurality of tenants associated with the data object based on a collaboration status of the plurality of tenants.

6. The method of claim 4, the tenant associated with a plurality of clients including the at least one client.

7. The method of claim 6, wherein a subset of the plurality of clients are permitted to access the data object based on the set of business rules associated with the tenant.

8. The method of claim 1, wherein determining the authentication status of the at least one client includes determining whether the at least one client is one of a plurality of clients authorized for access to the data object based on a collaboration status of the plurality of clients.

9. The method of claim 1, wherein the user information associated with the at least one client includes authentication information of the at least one client.

10. The method of claim 1 further comprising the following operations:
determine user information associated with a second client with access to the data object;
define a second hosted context storage including the data object and the user information associated with the second client;
receive a request for the data object from the second client;
determine an authentication status of the second client; and
provide the data object to the second client based on the authentication status of the second client.

11. A computer program product encoded on a tangible storage medium, the product comprising computer readable instructions for causing one or more processors to perform operations comprising:
receiving a data object for inclusion in a hosted context storage;
determining user information associated with at least one client with access to the data object;
storing the data object and the user information in the hosted context storage;
receiving a request for the data object from the at least one client;
determining an authentication status of the at least one client; and
providing the data object to the at least one client based on the authentication status of the at least one client.

12. The computer program product of claim 11, wherein storing the data object and the user information in the hosted context storage further comprises providing access to the hosted context storage through a cloud network.

13. The computer program product of claim 11, wherein determining the authentication status of the at least one client includes:
identifying a tenant associated with the at least one client, the tenant comprising a plurality of clients associated with a business organization, the plurality of clients including the at least one client; and
determining whether the at least one client is authorized to access the data object based on a set of business rules associated with the tenant.

14. The computer program product of claim 13, wherein identifying a tenant associated with the at least one client includes determining whether the tenant is one of a plurality of tenants associated with the data object based on a collaboration status of the plurality of tenants.

15. The computer program product of claim 13, wherein a subset of the plurality of clients are permitted to access the data object based on the set of business rules associated with the tenant.

16. The computer program product of claim 11, wherein determining the authentication status of the at least one client includes determining whether the at least one client is one of a plurality of clients authorized for access to the data object based on a collaboration status of the plurality of clients.

17. The computer program product of claim 11, further comprising computer readable instructions for causing the one or more processors to perform operations comprising:
receiving a second data object to be accessed by the at least one client;
defining a second hosted context storage including the second data object and the user information associated with the at least one client;
receiving a request for the second data object from the at least one client;
determining an authentication status of the at least one client; and
providing the second data object to the at least one client based on the authentication status of the at least one client.

18. A system, comprising:
memory operable to store at least one data object accessible to a set of clients; and
one or more processors operable to:
receive a data object for inclusion in the memory;
determine user information associated with at least one client in the set of clients;
store the data object and the user information in the memory;
receive a request for the data object from the at least one client;
determine an authentication status of the at least one client; and
provide the data object to the at least one client based on the authentication status of the at least one client.

19. The system of claim 18, wherein storing the data object and the user information in the hosted context storage comprises providing access to the hosted context storage through a cloud network.

20. The system of claim 18, wherein to determine an authentication status of the at least one client, the one or more processors are further operable to:
identify a tenant associated with the at least one client; and
determine whether the at least one client is authorized to access the data object based on a set of business rules associated with the tenant.
